(19) United States
(12) Patent Application Publication
(10) Pub. No.: US 2009/0262044 A1
(43) Pub. Date: Oct. 22, 2009

(54) Display Device

(75) Inventors: Masaki Otsuki, Yokohama-shi (JP); Satoshi Ejima, Tokyo (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/309,491

(22) PCT Filed: Jul. 25, 2007
(86) PCT No.: PCT/JP2007/064562

§ 371 Date: Jan. 21, 2009

(30) Foreign Application Priority Data
Aug. 2, 2006 (JP) 2006-210827

(51) Int. Cl. G09G 5/00

(52) U.S. Cl. 345/8

(57) ABSTRACT

In a head-mounted display (1), functions of a cross key (7) are displayed on a display section (6) immediately after the power is turned on, as shown in A in FIG. 1(a). The functions displayed are FF (fast forward), REW (rewind), Vol+ (increase sound volume), and Vol− (decrease sound volume), and thus, only the operation for changing voice information is possible. That is, the functions of the head-mounted display (1) immediately after the power is turned on are those for handling only the voice information, and functions for video information are not included in them. After the power is turned on, if the user desires video information, they push a push button switch (8). This causes video information, such as a music title selection screen, to be displayed as shown in B in FIG. 1(b), and operation of the cross key (7) provides a mode in which the content of video information can be changed. The display device facilitates operation when the user starts to use it.

### TECHNICAL FIELD

The present invention relates to a display device.

### BACKGROUND ART

Recently there have been various glasses-type video display devices in which video displayed on a display device such as a Liquid Crystal Display (LCD) is observed as a virtual image enlarged through an optical system having an eyepiece lens, a half mirror, or the like. The glasses-type video display devices are called a head-mounted display. For example, WO2004/061519A1 (Patent Document 1) discloses a head-mounted display.

Many such type video display devices are configured in such a way that they are worn on a face while wrapped around a head. Such type video display devices are mainly divided into a binocular type in which the video display system is formed at positions corresponding to eyes and a monocular type in which the video display system is formed at a position corresponding to one of the right and left eyes. Usually the head-mounted display includes a display unit which displays video and a headphone which supplies sound.

Patent Document 1: WO2004/061519A1

### DISCLOSURE OF THE INVENTION

### Problem to be Solved by the Invention

Unlike conventional displays, because a display panel such as LCD is observed through an eyepiece lens in the head-mounted display, disadvantageously video image cannot be observed when a position of the eye is correctly disposed relative to the eyepiece lens.

Some head-mounted displays or an AV players connected to the head-mounted displays have a sound reproduction function of reproducing sound and a moving-image reproduction function of reproducing video image. With these devices, in the case where a user turns on the head-mounted display to reproduce music, disadvantageously it is necessary to switch the operation mode while the user views the screen when a mode of the head-mounted display is set at a moving-image reproduction mode.

At this point, as described above, because the work in which the position of the eyepiece lens is correctly set to observe the video image is required in the head-mounted display, the work for switching the operation mode becomes troublesome for the user. When the user continues the manipulation without observing the video image, unfortunately sometimes an unintended operation state may be generated and the user may be confused.

In view of the foregoing, an object of the present invention is to provide a display device which easily performs the manipulation at the beginning of the use.

### Means for Solving the Problem

In order to solve the problem, a first aspect according to the present invention is a display device which is mounted on a head and has a display unit which directly projects a video image to an eye of a user, the display device including a sound output unit which supplies sound; and a manipulation member for manipulating the display device or a device connected to the display device, wherein manipulation by the manipulation member includes first manipulation for changing supplied sound information and second manipulation for changing supplied video information, the first manipulation can be performed immediately after use of the display device is started, and the display device includes an input member with which a user switches the display device from a state in which the first manipulation can be performed to a state in which the second manipulation can be performed.

In order to solve the problem, a second aspect according to the present invention is a display device which is mounted on a head and has a display unit which directly projects a video image to an eye of a user, the display device including a sound output unit which supplies sound; and a manipulation member for manipulating the display device or a device connected to the display device, wherein manipulation by the manipulation member includes first manipulation for changing supplied sound information and second manipulation for changing supplied video information, the first manipulation can be performed immediately after use is started, and the display device includes an input member with which a user is enabled to switch the display device to a state in which the second manipulation can be performed.

In order to solve the problem, a third aspect according to the present invention is the display device of the first or second aspect, wherein the display device has a first state in which video image can be projected to the eye of the user and a second state in which video image cannot be projected to the eye of the user, and the input member is manipulated by switching between the first state and the second state.

In order to solve the problem, a fourth aspect according to the present invention is the display device of one of the first to third aspects, characterized in that one of lowering of luminance of a display video image, stop of video display, a transition to a power saving mode of a video display circuit, and stop of electric power supply to the video display circuit is enabled in a state in which the first manipulation can be performed, and the display device is returned from the enabled state by manipulation of the input member.

In order to solve the problem, a fifth aspect according to the present invention is the display device of one of the first to fourth aspects, wherein a member which indicates whether the display device is in a state in which video information changing manipulation can be performed or in a state in which sound information manipulation can be performed is provided independently of the display device.

The present invention can provide the display device which easily performs the manipulation at the beginning of the use.

### BRIEF DESCRIPTION OF DRAWINGS

FIG. 1 is a view showing an outline of a head-mounted display according to a first embodiment of the present invention.

FIG. 2 is a view showing an outline of a head-mounted display according to a second embodiment of the present invention.

FIG. 3 is a view showing an outline of a head-mounted display according to a third embodiment of the present invention.

### EXPLANATIONS OF LETTERS OR NUMERALS

1 head-mounted display

2 headphone housing

3 headphone housing

4 joint unit

5 support arm

6 display unit

7 cross key

8 push-button switch

### BEST MODES FOR CARRYING OUT THE INVENTION

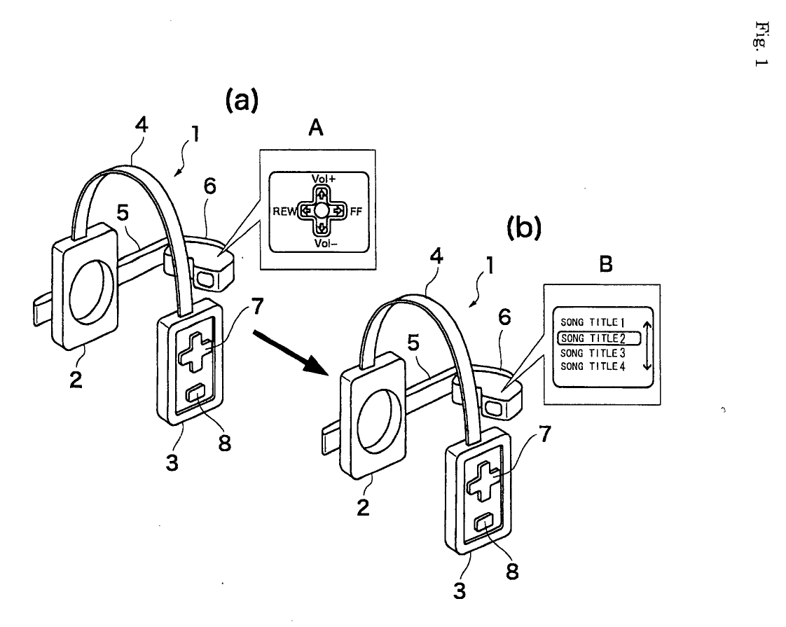

Exemplary embodiments of the present invention will be described with reference to the drawings. FIG. 1 is a view showing an outline of a head-mounted display according to a first embodiment of the present invention. A head-mounted display 1 which is of the display device includes headphone housings 2 and 3, and the headphone housings 2 and 3 are connected by an elastic joint unit 4. A support arm 5 is attached to the headphone housing 2, and a display unit 6 which displays video to the eye is attached to a leading end portion of the support arm 5. The display unit 6 includes a display device such as LCD and an eyepiece optical system which projects an image of the display device to a retina of a user. When the head-mounted display 1 is used, ears are sandwiched between the headphone housings 2 and 3, positions of the support arm 5 and display unit 6 are adjusted while the joint unit 4 is located in a head top direction in such a way that the display unit 6 is located in front of the eye.

A cross key 7 and a push-button switch 8 are provided in the headphone housing 3. The cross key 7 is of manipulation members for manipulating the head-mounted display 1 or a device connected to the head-mounted display 1. A power supply circuit, a video display circuit, a sound output circuit, a signal processing circuit, a storage unit, and a control unit are provided in at least one of the headphone housings 2 and 3. The video display circuit controls the display device. The sound output circuit supplies a sound signal to the headphones. The signal processing circuit reproduces content data. The storage unit stores the content data. The control unit detects an input from various keys, a push-button switch, a limit switch, and the like and controls various circuits.

In the head-mounted display 1, immediately after the power-on, a function of the cross key 7 is displayed on the display unit 6 as shown in a part A of FIG. 1(a). What are displayed include FF (fast-forward), REW (rewind), Vol+ (turn-up of volume), and Vol− (turn-down of volume), and therefore only manipulation for changing sound information can be performed. It is not always necessary to display the function of the cross key 7 immediately after the power-on.

That is, immediately after the power-on, the head-mounted display 1 has only a function of handling sound information, and the head-mounted display 1 does not have a function of handling video information. When a user turns on the power to obtain sound information, the head-mounted display 1 does not have a function of handling video information. As a result, the user is not required to perform troublesome work in which the user manipulates the cross key 7 to make the head-mounted display 1 have a function of handling only sound information, while viewing the display of the display unit 6.

After the power-on, when the user wants to obtain video information, the user presses the push-button switch 8. Then, as shown in a part B of FIG. 1(b), video information such as a song title selection screen is displayed the device is placed in a mode in which video information can be changed by manipulating the cross key 7.

In a mode in which only manipulation for changing sound information can be performed (corresponding to FIG. 1(a)), manipulation may be performed by the control unit such that one of lowering of luminance of the display video image, stop of video display, a transition to a power saving mode of the video display circuit, and stop of electric power supply to the video display circuit can be fed. This enables power saving to be achieved. In the case where the above-described operation has been performed, automatic return should desirably be performed from the operation when a transition is made to the mode in which video information can be changed by manipulation of the push-button switch 8. Further, after a predetermined time elapses after a transition has been made to the mode in which only manipulation for changing sound information can be performed, one of the lowering of luminance of the display video image, the stop of video display, the transition to the power saving mode of the video display circuit, and the stop of electric power supply to the video display circuit may be performed.

In the example shown in FIG. 1, one of the state in which only manipulation for changing sound information can be performed (state of FIG. 1(a)) and the state in which video information can be changed (state of FIG. 1(b)) is selected using the cross key 7 which is of a manipulating device. A manipulating device for sound manipulation and a manipulating device for video manipulation may be separately provided, and the manipulating device for video manipulation may be disabled in the state in which only manipulation for changing sound information can be performed.

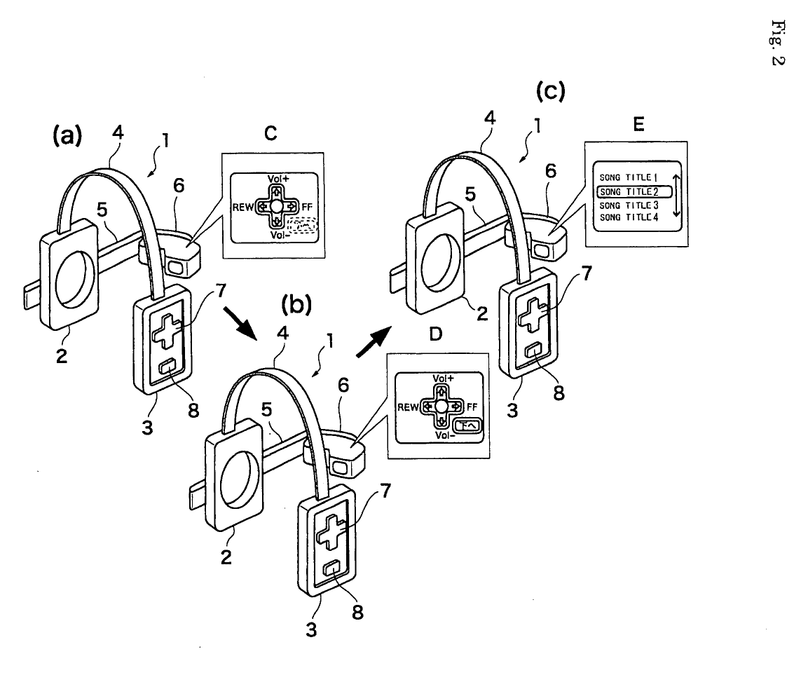

FIG. 2 is a view showing an outline of a head-mounted display according to a second embodiment of the present invention. In the following drawings, the same component as that of FIG. 1 is designated by the same numeral, and sometimes the description will be omitted.

In the head-mounted display 1 of the second embodiment, immediately after the power-on, a function of the cross key 7 is displayed on the display unit 6 as shown in a part C of FIG. 2(a). What are displayed include FF (fast-forward), REW (rewind), Vol+ (turn-up of volume), and Vol− (turn-down of volume), and therefore only manipulation for changing sound information can be performed. At the same time, although the push-button switch 8 is also displayed, the function of the push-button switch 8 is not displayed. It is not always necessary to display the cross key 7 and the push-button switch 8 immediately after the power-on.

That is, immediately after the power-on, the head-mounted display 1 has only a function of handling sound information, and the head-mounted display 1 does not have a function of handling video information. When the user turns on the power to obtain only sound information, the head-mounted display 1 does not have a function of handling video information. As a result, the user is not required to perform the troublesome work in which the user manipulates the cross key 7 to make the head-mounted display 1 have a function of handling only sound information, while viewing the display of the display unit 6.

When the user wants to obtain video information after the power-on, the user presses the push-button switch 8. Then, as shown in a part D of FIG. 2(b), function of “downward” is displayed in the display of the push-button switch 8, showing that the push-button switch 8 has obtained a function of making a transition to a lower level of hierarchy. If the user mistakenly presses the push-button switch 8, the display can be returned to the display shown in the part C of FIG. 2(a) by manipulation of the cross key 7.

When the user presses the push-button switch 8 again while “downward” is displayed in the push-button switch 8 on the screen, a transition is made to the lower level of hierarchy, and the display of the screen becomes a part E of FIG. 2(c) to display a song title selection of music like the part B of FIG. 1(b). The following operating steps are similar to those of the head-mounted display 1 of the first embodiment of FIG. 1.

That is, in the second embodiment, the head-mounted display 1 does not make a transition to the song title selection even if the user presses the push-button switch 8 once, but the head-mounted display 1 makes a transition to a mode in which the user is allowed to start song title selection manipulation (second manipulation) when the user presses the push-button switch 8 once. Thus, because the manipulation is divided into two stages, a wrong manipulation can be prevented even if the user mistakenly presses the push-button switch 8.

In the head-mounted display 1 of the second embodiment, the display control and the button assignment are performed by the control unit included in the headphone housing 2 or 3, and the video output circuit supplies video image under the control of the control unit.

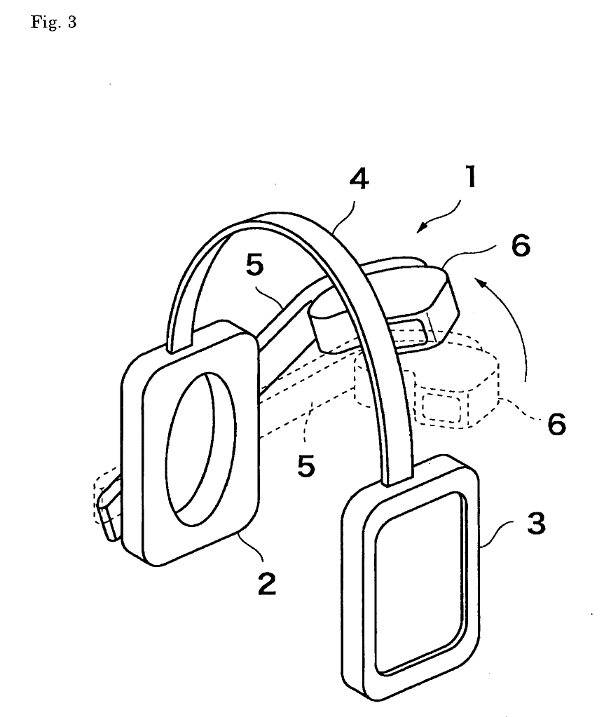

FIG. 3 is a view showing an outline of a head-mounted display according to a third embodiment of the present invention. In the third embodiment, as shown in FIG. 3, the support arm 5 is vertically turned about a turning shaft provided in the headphone housing 2. The position at which the user views video image is shown by a broken line. The position at which the user does not view video image is shown by a solid line, and the display unit 6 is distant from the eye position in this case. When the support arm 5 and the display unit 6 is located at the position shown by the solid line, because display of video image is not used, the head-mounted display 1 is placed in a sound mode in which only sound output is delivered. When the support arm 5 and the display unit 6 is located at the position shown by the broken line, the head-mounted display 1 is a placed in a video mode in which video image can be displayed.

Switching the device in such a way as described above can prevent a waste video image display. Whether the support arm 5 and the display unit 6 are located in the broken-line state or in the solid-line state can be detected, for example, by a limit switch provided on the turning shaft of the headphone housing 2, or the like. In such cases, the limit switch or the like corresponds to “input member”.

Inconveniently sometimes whether the head-mounted display 1 is placed in the sound mode or in the video mode cannot be recognized from the outside. Therefore, an indication device except for the display unit 6 of the head-mounted display 1 should preferably be provided at a position visible from the outside to indicate whether the head-mounted display 1 is placed in the sound mode or in the video mode. Thus, the user can mount the head-mounted display 1 after having recognized the operation mode, so that the user can smoothly perform the function switching manipulation. The display of the operation mode may be performed in the form of a graphic or characters with LCD or the like, or the display of the operation mode may be performed only by turn-on and turn-off of a LED or the like.

1. A display device which is mounted on a head and has a display unit which directly projects a video image to an eye of a user, the display device comprising:
a sound output unit which supplies sound; and
a manipulation member for manipulating the display device or a device connected to the display device,
wherein manipulation by the manipulation member includes first manipulation for changing supplied sound information and second manipulation for changing supplied video information,
the first manipulation can be performed immediately after use of the display device is started, and
the display device includes an input member with which a user switches the display device from a state in which the first manipulation can be performed to a state in which the second manipulation can be performed.

2. A display device which is mounted on a head and has a display unit which directly projects a video image to an eye of a user, the display device comprising:
a sound output unit which supplies sound; and
a manipulation member for manipulating the display device or a device connected to the display device,
wherein manipulation by the manipulation member includes first manipulation for changing supplied sound information and second manipulation for changing supplied video information,
the first manipulation can be performed immediately after use is started, and
the display device includes an input member with which a user is enabled to switch the display device to a state in which the second manipulation can be performed.

3. The display device according to claim 1, wherein the display device has a first state in which video image can be projected to the eye of the user and a second state in which video image cannot be projected to the eye of the user, and
the input member is manipulated by switching between first state and the second state.

4. The display device as in claim 1, wherein one of lowering of luminance of a display video image, stop of video display, a transition to a power saving mode of a video display circuit, and stop of electric power supply to the video display circuit is enabled in a state in which the first manipulation can be performed, and
the display device is returned from the enabled state by manipulation of the input member.

5. The display device as in claim 1, wherein a member which indicates whether the display device is in a state in which video information changing manipulation can be performed or in a state in which sound information manipulation can be performed is provided independently of the display device.
